(19) United States
(12) Patent Application Publication
(10) Pub. No.: US 2003/0188322 A1
(43) Pub. Date: Oct. 2, 2003

(54) Method and system for remotely displaying television program content using streaming video

(75) Inventor: Raymond C. Bontempi, Jamison, PA (US)

Correspondence Address: AKIN GUMP STRAUSS HAUER & FELD L.L.P., ONE COMMERCE SQUARE, 2005 MARKET STREET, SUITE 2200, PHILADELPHIA, PA, 19103-7013, US

(73) Assignee: General Instrument Corporation

(21) Appl. No.: 10/108,924

(22) Filed: Mar. 28, 2002

(51) Int. Cl. H04N 7/16; H04N 7/173

(52) U.S. Cl. 725/139; 725/100; 725/131; 725/151

(57) ABSTRACT

A selected program channel of a video signal, received and tuned to by a set-top box (STB), is simultaneously displayed on a television and on a display of an auxiliary display device that controls the selection of program channels displayed on the television. The STB has a first and second interface. The STB selects the program channel and sends the selected program channel, via the first interface, to a television which displays program content of the selected program channel. The STB encodes the selected program channel into a streaming video signal and sends the streaming video signal to the auxiliary display device via the second interface. The auxiliary display device decodes the streaming video signal into the selected program channel and displays the program content of the selected program channel.

### BACKGROUND OF THE INVENTION

1. Field of the Invention

The present invention generally relates to the processing and display of video program signals in a cable television (CATV) environment.

2. Background Information

The Advanced Television Enhancement Forum (ATVEF) was formed in 1997 by a consortium of 14 leading companies in the television and computing industries. This group developed a public, worldwide specification for creating and delivering interactive TV (ITV) content. In 1999, the ATVEF Specification v1.1, r26 was finalized and published. The ATVEF Specification serves as a standard for creating enhanced, interactive television content and delivering that content to a range of television, set-top, and PC-based receivers. The ATVEF Specification uses existing Internet technologies to deliver enhanced TV programming over both analog and digital video systems using terrestrial, cable, satellite and Internet networks. The ATVEF Specification can be used in both one-way broadcast and two-way video systems, and is designed to be compatible with all international standards for both analog and digital video systems.

Television enhancements are comprised of three related data sources: announcements (delivered via SAP), content (delivered via UHTTP), and triggers (delivered via the trigger protocol over UDP). SAP (Session Announcement Protocol) is a protocol used for session announcements. UHTTP (Unidirectional Hypertext Transfer Protocol) is a simple, robust, one-way resource transfer protocol that is designed to efficiently deliver resource data in a one-way broadcast-only environment. UDP (User Datagram Protocol) is an Internet Standard transport layer connection-less protocol which adds a level of reliability and multiplexing to IP. IP is one of the communication languages used by computers connected to the Internet. This resource transfer protocol is appropriate for Internet Protocol (IP) multicast over a television vertical blanking interval (VBI), IP multicast carried over MPEG, or other unidirectional transport systems. MPEG (Moving Picture Experts Group) is the name of a family of standards used for coding audio-visual information (e.g., movies, video, music) in a digital compressed format. The major advantage of MPEG compared to other video and audio coding formats is that MPEG files are much smaller for the same quality. This is because MPEG uses very sophisticated compression techniques.

Thus, with the advent of ATVEF and digital cable TV, a new era in TV viewing experience is emerging in which video complementary data services are available to the TV viewer. There are many potential methods for experiencing these data services. One such way is to use a second display screen on an auxiliary display device. One example of an auxiliary display device is a webpad, which is a relatively small remote wireless device which has a touch-screen display and a wireless connection to a cable (or satellite) set-top box (STB). A webpad provides web surfing, email, and access to other Internet functions.

FIG. 1 shows a conventional two-screen digital cable TV system 100. The TV system 100 includes a digital STB 105 which communicates with over an auxiliary display device 110 over a wireless connection. The wireless connection utilizes an RF bridge internal to the digital STB 105, or an external RF bridge 120 connected to an external interface 115 on the digital STB 105, such as a Universal serial bus (USB), Ethernet, or IEEE 1394 interface that communicates with the auxiliary display device 110 over a wireless radio frequency (RF) link 125. The RF bridge 120 in this scenario is a device designed for a specific interface (e.g., USB) and is used to support wireless connectivity. Typical wireless connection protocols that may be used by TV system 100 include, but are not limited to, HomeRF® and IEEE 802.11. A more traditional wired connection simply includes a cable or wire between the digital STB 105 and the auxiliary display device 110, again using a USB, Ethernet, or IEEE 1394 interface.

The auxiliary display device 110 communicates with a cable modem 150 within digital STB 105 to access the Internet 135. A video signal including a plurality of program channels is sent from TV video programming provider 140 to a tuner/decoder 145 within the digital STB 105. The tuner decoder 145 selects one of the program channels and sends the selected program channel to television 130 for display. Selection of the program channels can be performed locally at the digital STB 105, or remotely when signals received by a remote control circuit 170 within auxiliary display device 110 are received by tuner/decoder 145 via remote control input interface 155. When Internet data is received from the Internet 135 by the remote receiver 160 of the auxiliary display device 110, a user can view the Internet data on display 165 and interact with the Internet 135 without interfering with the selected program channel viewed on the television 130.

In the conventional TV system 100 shown in FIG. 1, the selected program channel displayed on television 130 cannot be viewed on display 165 of the auxiliary display device 110. A feature is desired that enables a user of the auxiliary display device 110 to view on display 165 the selected program channel tuned to by STB 105 and shown on television 130, without having to install expensive hardware into the auxiliary display device 110. Such a feature would allow a user to watch the selected program channel tuned to by STB 105 on a portable device, when the user is not in the immediate vicinity of television 130.

### SUMMARY OF THE INVENTION

The present invention enables a selected program channel of a video signal, received and tuned to by a set-top box (STB), to be simultaneously displayed on a television and on a display of an auxiliary display device that controls the selection of program channels displayed on the television

Video program content is remotely displayed in a communications system that includes an auxiliary display device and an STB. The STB receives and processes a video signal including a plurality of program channels. The STB has a first and second interface. The STB selects one of the program channels and sends the selected program channel, via the first interface, to a television which displays program content of the selected program channel. The STB encodes the selected program channel into a streaming video signal. The STB sends the streaming video signal to the auxiliary display device via the second interface. The auxiliary display device decodes the streaming video signal into the selected program channel. The auxiliary display device displays the program content of the selected program channel. The auxiliary display device may be used to control the STB to select the program channels. The streaming video signal may be transmitted over a wireless medium. The selected program channel may be formatted in an MPEG (Moving Picture Experts Group) format. The communications system may be a cable television (CATV) system.

### BRIEF DESCRIPTION OF THE DRAWINGS

The following detailed description of preferred embodiments of the present invention would be better understood when read in conjunction with the appended drawings. For the purpose of illustrating the present invention, there are shown in the drawings embodiments which are presently preferred. However, the present invention is not limited to the precise arrangements and instrumentalities shown. In the drawings:

FIG. 1 is a block diagram of a conventional two-screen digital cable TV system;

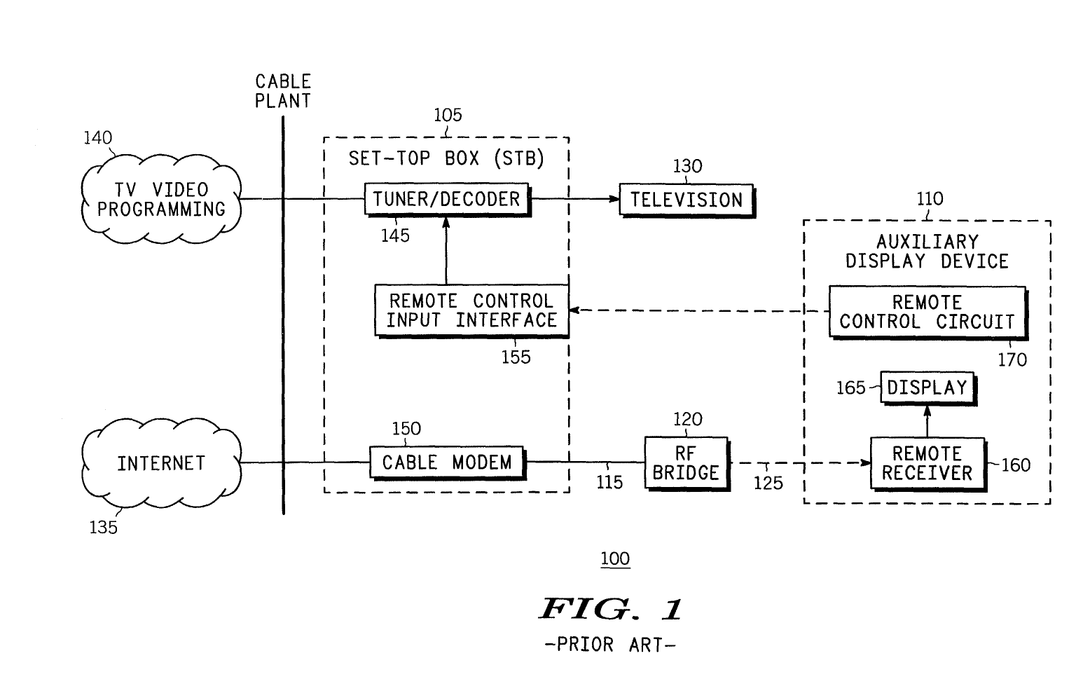

FIG. 2 is a block diagram of a communications system in accordance with the present invention; and

FIG. 3 is a high-level functional flowchart including steps implemented by the communications system of FIG. 2.

### DETAILED DESCRIPTION OF THE INVENTION

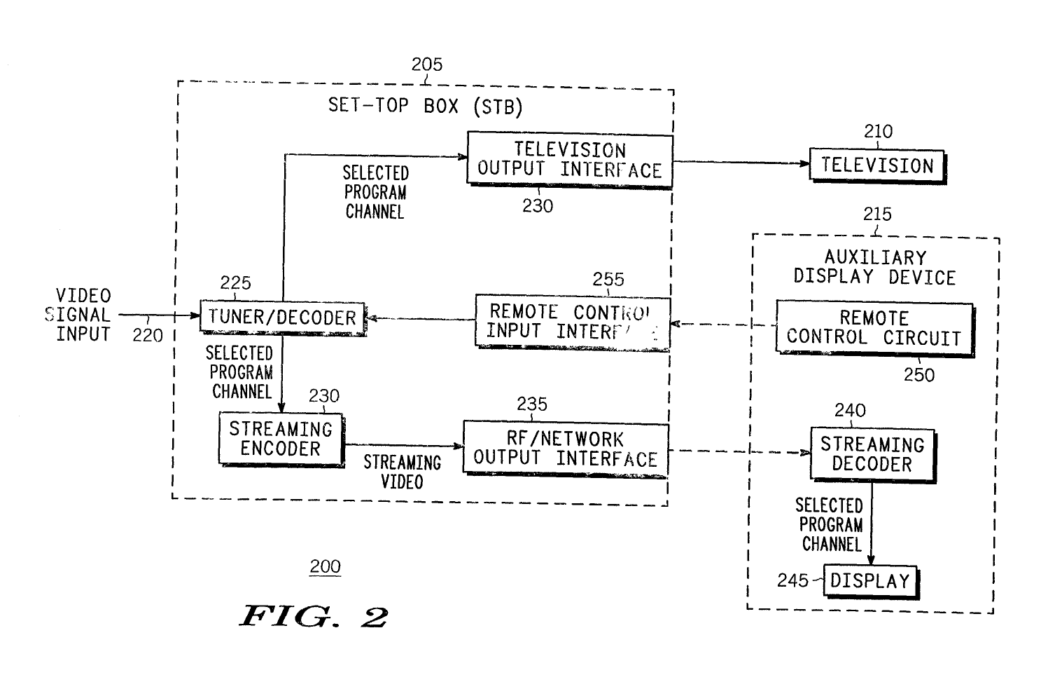

FIG. 2 shows a communications system 200 (e.g., a CATV system) including a set-top box (STB) 205 in communication with a television 210 and an auxiliary display device 215. The communications system 200 remotely displays video program content received via video signal input 220. The STB 205 includes a tuner/decoder 225 that receives a video signal including a plurality of program channels from video signal input 220. The program channels consist of known National Television Standards Committee (NTSC) analog and Moving Picture Experts Group (MPEG) digital channels that an STB normally decodes and renders on a television.

The tuner/decoder 225 selects one of the program channels and sends the selected program channel to television 210 via a television output interface 230. The selected program channel can be formatted in an MPEG format. The tuner/decoder 225 also sends the selected program channel to a streaming encoder 230. The streaming encoder 230 encodes the selected program channel into a standard web-based streaming video signal at a high bit rate (e.g., Windows Streaming Media, Real Video) and sends the streaming video signal to the auxiliary display device 215 via an RF or network interface 235.

A web-based streaming decoder 240 within the auxiliary display device 215 receives the streaming video signal from the STB 205 and decodes the streaming video signal into the selected program channel using a web browser. The streaming decoder 240 sends the selected program channel to a display 245. The functions of the streaming decoder can be implemented using hardware components, software, or both. Program content of the selected program channel is displayed on display 245 of the auxiliary display device 215 without having to add tuner/decoder hardware. The auxiliary display device 245 includes a remote control circuit 250 by which a user can wirelessly send signals to tuner/decoder 225 via remote control input interface 255 to change the selected channel.

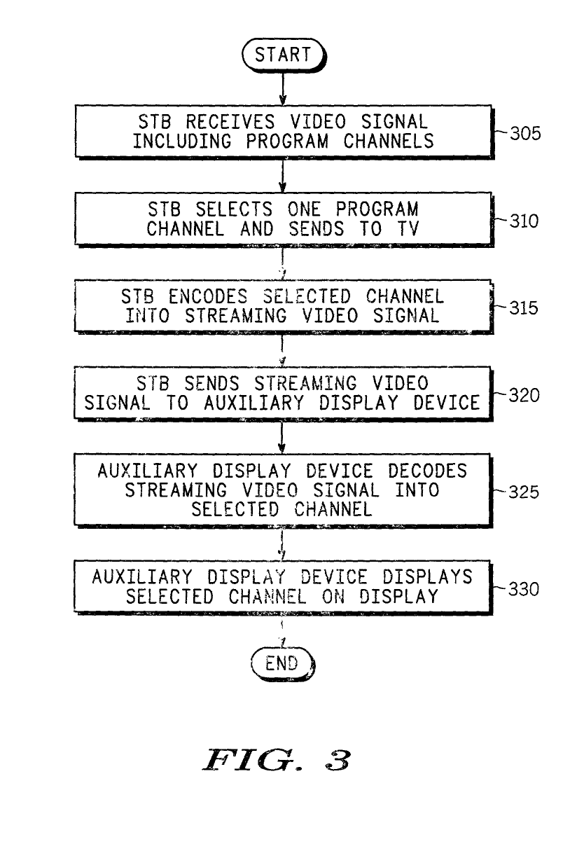

FIG. 3 shows the steps implemented by a method operating in accordance with the present invention. In step 305, the STB 205 receives and processes a video signal including a plurality of program channels. In step 310, the tuner/decoder 225 in STB 205 selects one of the program channels and sends the selected program channel, via the television output interface 230, to television 210 which displays program content of the selected program channel. In step 315, the streaming encoder 230 in STB 205 encodes the selected program channel into a streaming video signal. In step 320, the streaming encoder 230 in STB 205 sends the streaming video signal to the auxiliary display device 215 via the RF or network interface 235 at the highest bit rate that the RF or interface 235 will allow to provide the highest quality video with minimal processing. In step 325, the streaming decoder 255 of auxiliary display device 215 decodes the streaming video signal into the selected program channel. In step 330, the auxiliary display device 215 displays the program content of the selected program channel on display 245.

The present invention may be implemented with any combination of hardware and software. If implemented as a computer-implemented apparatus, the present invention is implemented using means for performing all of the steps and functions described above.

The present invention can be included in an article of manufacture (e.g., one or more computer program products) having, for instance, computer useable media. The media has embodied therein, for instance, computer readable program code means for providing and facilitating the mechanisms of the present invention. The article of manufacture can be included as part of a computer system or sold separately.

It will be appreciated by those skilled in the art that changes could be made to the embodiments described above without departing from the broad inventive concept thereof It is understood, therefore, that this invention is not limited to the particular embodiments disclosed, but it is intended to cover modifications within the spirit and scope of the present invention as defined by the appended claims.

What is claimed is:

1. A method of remotely displaying video program content in a communications system, the system including an auxiliary display device and a set-top box (STB) that receives and processes a video signal including a plurality of program channels, the STB having a first and second interface, the method comprising:
(a) the STB selecting one of the program channels and sending the selected program channel, via the first interface, to a television which displays program content of the selected program channel;
(b) the STB encoding the selected program channel into a streaming video signal;
(c) the STB sending the streaming video signal to the auxiliary display device via the second interface;
(d) the auxiliary display device decoding the streaming video signal into the selected program channel; and
(e) the auxiliary display device displaying the program content of the selected program channel.

2. The method of claim 1 wherein step (a) further comprises using the auxiliary display device to control the STB to select the program channels.

3. The method of claim 1 wherein step (c) further comprises transmitting the streaming video signal over a wireless medium.

4. The method of claim 1 wherein the selected program channel is formatted in an MPEG (Moving Picture Experts Group) format.

5. A communications system for remotely displaying video program content, the system comprising:
(a) a set-top box (STB) that (i) receives a video signal including a plurality of program channels, (ii) selects one of the program channels, and (iii) encodes the selected program channel into a streaming video signal, the STB having a first and second interface; and
(b) an auxiliary display device that (i) receives the streaming video channel from the STB, (ii) decodes the streaming video signal into the selected program channel, and (iii) displays program content of the selected program channel, wherein the STB sends the program channel to a television via the first interface, and the STB sends the streaming video signal to the auxiliary display device via the second interface.

6. The system of claim 5 wherein the STB has a third interface, and the auxiliary display device includes a transmitter used to wirelessly control the STB to select the program channels via the third interface.

7. The system of claim 5 wherein the STB sends the streaming video signal to the auxiliary display device via a wireless medium.

8. The system of claim 5 wherein the selected program channel is formatted in an MPEG (Moving Picture Experts Group) format.

9. The system of claim 5 wherein the communications system is a cable television (CATV) system.
